(19) United States
(12) Patent Application Publication
(10) Pub. No.: US 2011/0091161 A1
(43) Pub. Date: Apr. 21, 2011

(54) OPTICAL CONNECTOR WITH AN IMPROVED RESILIENT MEMBER PRESSING ONTO AN OPTICAL MODULE THEREOF

(75) Inventors: JIA-YONG HE, Kunshan (CN); QI-SHENG ZHENG, Kunshan (CN)

(73) Assignee: HON HAI PRECISION INDUSTRY CO., LTD., Tu-Cheng (TW)

(21) Appl. No.: 12/907,052

(22) Filed: Oct. 19, 2010

(30) Foreign Application Priority Data
Oct. 19, 2009 (CN) 200920312771.9

(51) Int. Cl. G02B 6/38

(52) U.S. Cl. 385/74; 385/55; 385/75

(57) ABSTRACT

An optical connector comprises an insulative housing defining a mounting cavity; an optical module accommodated in the mounting cavity and capable of moving therein along a front-to-rear direction, the optical module defining a horizontal central line along a middle portion thereof in the front-to-rear direction; at least one fiber coupled to the optical module; and a resilient member located behind the optical module, and having a first abuting portion engaged with the insulative housing, and two second abuting portions extending forwardly from the first abutting portion and pressing onto the optical module. The two second abuting portions are spaced away from each other in a transverse direction perpendicular to the front-to-rear direction.

### BACKGROUND OF THE INVENTION

1. Field of the Invention

The present invention relates to an optical connector, more particularly to an optical connector with an improved resilient member pressing onto an optical module thereof.

2. Description of Related Art

Universal Serial Bus (USB) is widely used in variety electric devices as a standard and simple interface. Until now, USB specification has went through 0.9, 1.0, 1.1, 2.0 and 3.0 versions. Speed data rate of USB connector is gradually increased at the same time for adapting the rapid development of electric industry. Recently, designers further design a new connector which is added optical fibers to USB 3.0 for supplying an even higher data rate than USB 3.0 and achieving remote signal transmission. The new connector is an optical connector, and comprises an insulative housing, USB 3.0 contacts retained on the insulative housing, an optical module received in the insulative housing to transmit optical signal, and a coil spring sandwiched between the optical module and the housing along a front-to-rear direction. Therefore, the optical connector is based on USB interface and can mate with a USB connector. The optical module has a lens and a plurality of fibers partly received in the lens. The fibers extend out of a rear end of lens to connect with a cable behind the optical connector. The insulative housing defines a receiving cavity to receive the optical module. And the optical module can move in the receiving cavity along an insertion direction of a mating connector. However, in a mating process of the mating connector, the optical module would be resisted backwardly and shakes along a transverse direction until the mating connector exactly connect with the optical connector.

Hence, an improved optical connector is desired to overcome the above problems.

### BRIEF SUMMARY OF THE INVENTION

In order to achieve the above-mentioned object, an optical connector in accordance with present invention comprises an insulative housing defining a mounting cavity; an optical module accommodated in the mounting cavity and capable of moving therein along a front-to-rear direction, the optical module defining a horizontal central line along a middle portion thereof in the front-to-rear direction; at least one fiber coupled to the optical module; and a resilient member located behind the optical module, and having a first abuting portion engaged with the insulative housing, and two second abuting portions extending forwardly from the first abutting portion and pressing onto the optical module; wherein the two second abuting portions are spaced away from each other in a transverse direction perpendicular to the front-to-rear direction.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an optical connector in accordance with a first embodiment of the present invention;

FIG. 2 is a partially assembled view of the optical connector shown in FIG. 1;

FIG. 3 is similar to FIG. 2, but viewed from another aspect;

FIG. 4 is a partially exploded view of FIG. 3;

FIG. 5 is an exploded view of the optical connector shown in FIG. 1;

FIG. 6 is similar to FIG. 5, but viewed from another aspect;

FIG. 7 is a partially exploded view of an optical connector in accordance with a second embodiment of the present invention; and

FIG. 8 is a further partially exploded view of FIG. 7.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

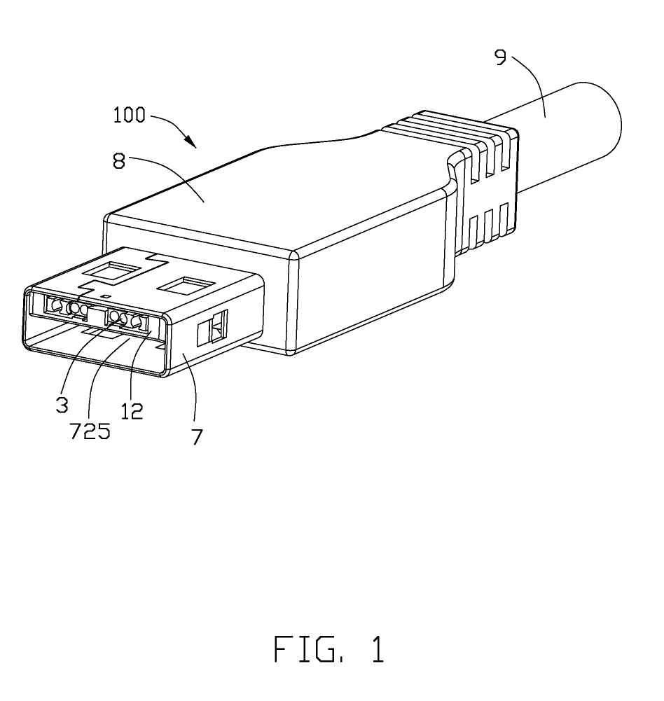

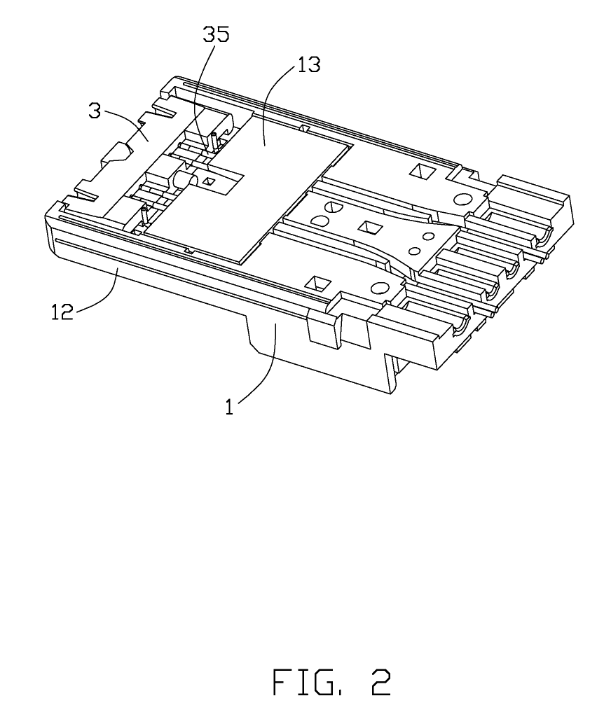

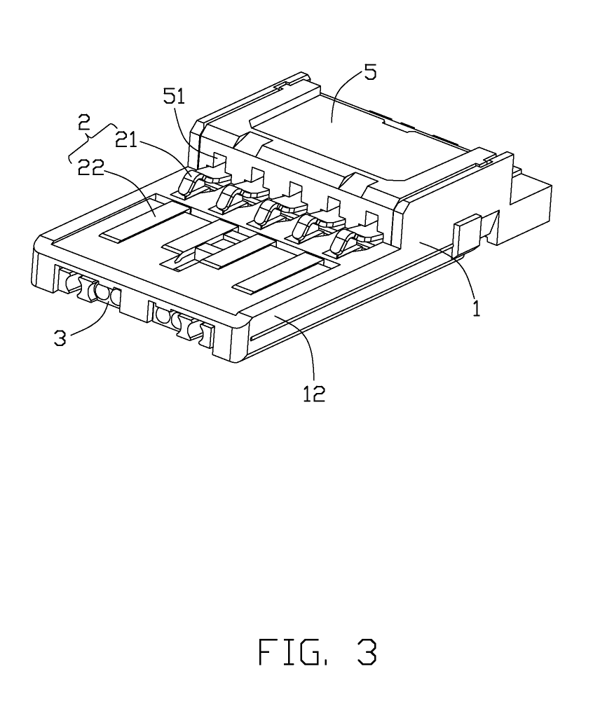

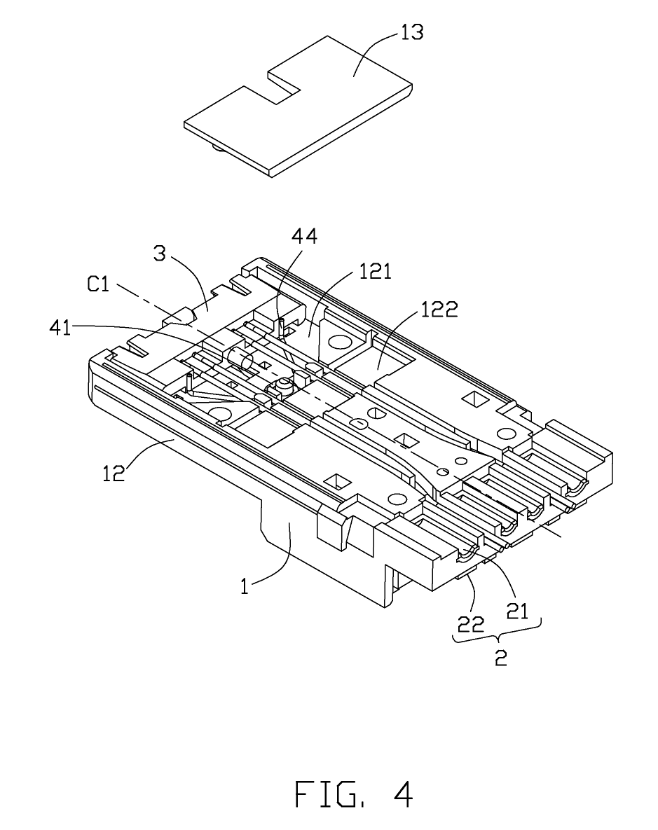

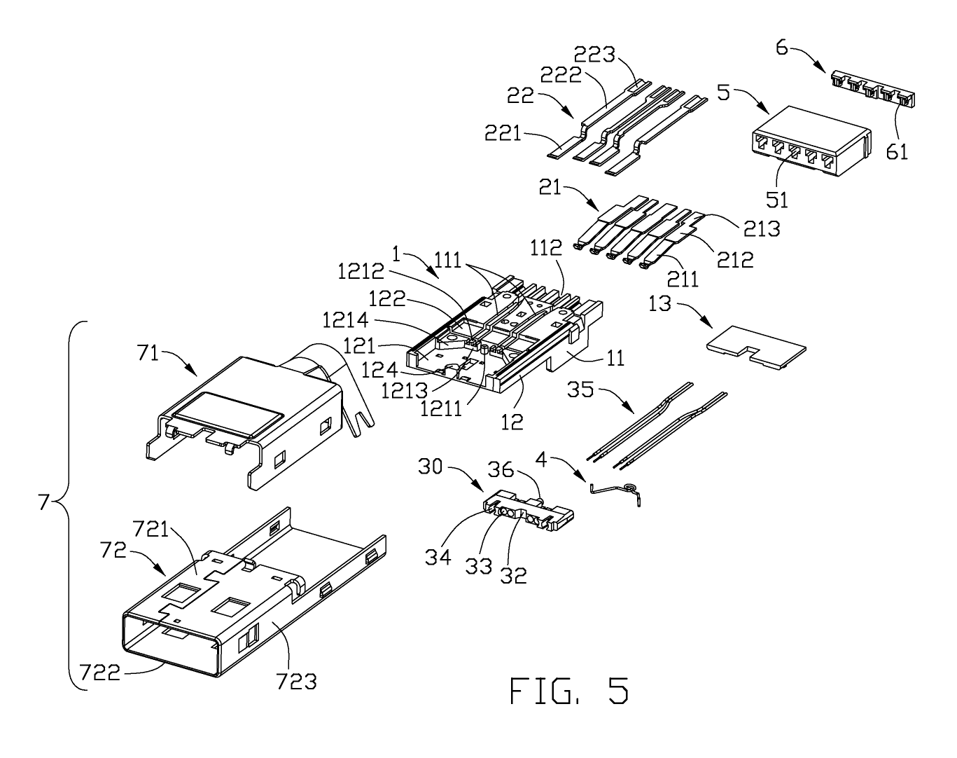

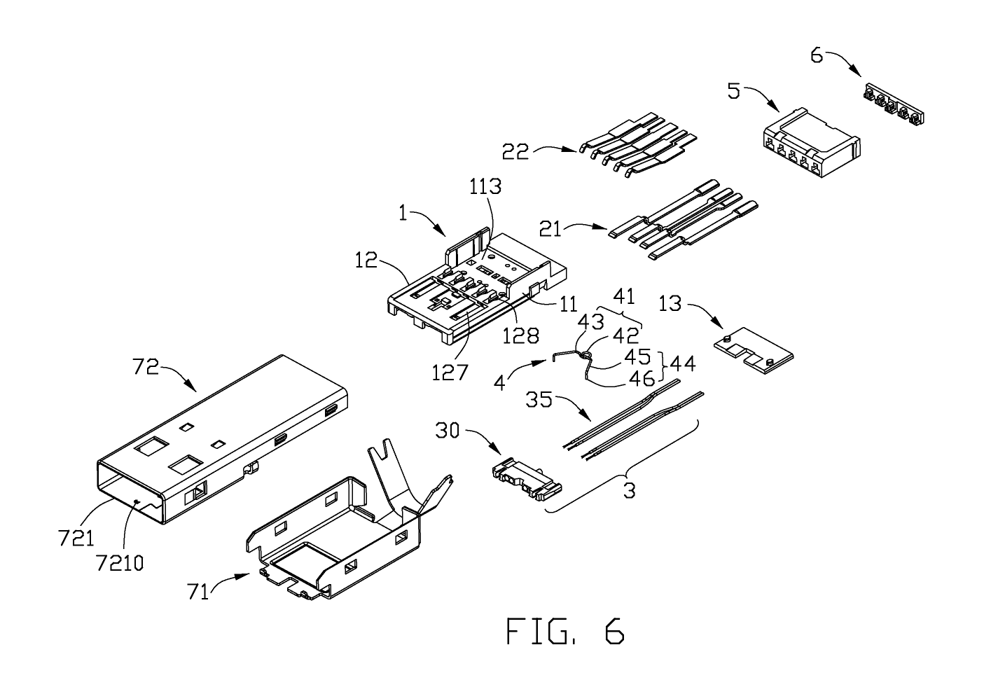

Referring to FIGS. 1-6, an optical connector 100 according to the first embodiment of the present invention is disclosed. The optical connector 100 comprises an insulative housing 1, a plurality of contacts 2 retained in the insulative housing 1, an optical module 3 disposed in the insulative housing 1, a metal resilient member 4 sandwiched between the optical module 3 and the insulative housing 1 along a front-to-rear direction, an insulator 5 retained in the insulative housing 1, a spacer 6 fastened on a rear side of the insulator 5, a metal shell 7 covering the insulative housing 1, an outer case 8 covering the metal shell 7, and a cable 9 connecting the contacts 2 and the optical module 3. The cable 9 has electrical wires and optical wires. Detail description of these elements and their relationship and other elements formed thereon will be detailed below.

The insulative housing 1 includes a base portion 11 and a tongue portion 12 extending forwardly from the base portion 11. A cavity 113 is recessed upwardly from a bottom surface (not numbered) of the base portion 11. A mounting cavity 121 is recessed downwardly from a top surface of the tongue portion 12. A stopping member 124 is formed in the front portion of the mounting cavity 121. An upright shaft 1211 is defined in the rear part of the tongue portion 12 and located within the mounting cavity 121. A pair of blocks 1212 are formed on two opposite sides of the shaft 1211 and located within the mounting cavity 121. The blocks 1212 are spaced away from the shaft 1211 to define a gap therebetween along a transverse direction perpendicular to the front-to-rear direction respectively and essentially align with the shaft 1211 along the transverse direction. The blocks 1212 each has a vertical surface 1213 perpendicular to the front-to-rear direction, and an incline surface 1214 extending forwardly and outwardly from the vertical surface 1213.

A depression 122 is define in a rear portion of the tongue portion 12 and communicating with the mounting cavity 121. A number of contact slots 112 are defined in an upper segment of a rear portion of the base portion 11. Four fiber grooves 111 are defined in the base portion 11 and extend along the front-to-rear direction, pass through the depression 122 and communicating with the mounting cavity 121.

The contacts 2 are based on the USB 3.0 standard, and include a first set of contacts 21, and a second set of contacts 22. The first contacts 21 have five contact members arranged in a row along the transverse direction and combined with the insulator 5. The first contacts 21 are separated into two pair of signal contacts for transmitting differential signals and a grounding contact disposed between the two pair of signal contacts. The first contacts 21 each includes a planar retention portion 212 received in corresponding groove 51 in the insulator 5, a curved mating portion 211 extending forward from the retention portion 212 and disposed beyond a front surface of the insulator 5, and a tail portion 213 extending rearwardly from the retention portion 212 and disposed behind a back surface of the insulator 5. A spacer 6 is assembled to a rear end of the insulator 5, with a number of ribs 61 thereof inserted into the grooves 51 to position the first contacts 4 in the insulator 5.

The second contacts 22 has four contact members arranged in a row along the transverse direction. The second contacts 22 each substantially includes a planar retention portion 222 supported by a bottom surface of the cavity 113, a mating portion 221 raised upwardly and extending forwardly from the retention portion 222 and disposed in a depression 122 of the lower section of the front segment of the tongue portion 12, and a tail portion 223 extending rearwardly from the retention portion 222 and accommodated in the contact slots 112 of the housing 1.

The insulator 5 is mounted to the cavity 113 of the base portion 11 and presses onto the retention portions 222 of the second contacts 22, with the mating portions 211 of the first contacts 211 located behind the mating portions 221 of the second contacts 22 and above the upper surface of the tongue portion 12, the tail portions 213 of the first contacts 21 arranged on a bottom surface of the rear segment of the base portion 11 and disposed lower than the tail portions 223 of the second contacts 22.

The optical module 3 comprises a holder member 30 movable in the mounting cavity 121 along the front-to-rear direction and four fibers 35 attached to the holder member 30. The holder member 30 defines a V-shaped indentation 32 recessed from a front end thereof to engage with the stopping member 124 for limiting a forward movement of the holder member 30. The holder member 30 is formed with two pairs of lenses 33 at a front side thereof, and a pair of position holes 34 recessed from the front end thereof and located at two outer sides of all lenses 33 respectively. The two pairs of lenses 33 are respectively located at two outer sides of the V-shaped indentation 32. The holder member 30 further has a positioning post 36 backwardly extending from a middle portion thereof, and a horizontal central line C1 along the middle portion in the front-to-rear direction. The position holes 34 are used to engage with a pair of posts on a corresponding mating connector (not shown) for aligning the optical connector 100 with the mating connector along the central line C1, then the lenses 33 can exactly face to lens on the mating connector for transmitting optical signals.

The fibers 35 are separated into two groups and pass through the fiber grooves 111, the depression 122, and enter the mounting cavity 121, respectively. An insulative cover 13 is positioned in the depression 122 to cover the mounting cavity 121 and the fiber grooves 111 for limiting the fibers 35 from moving upwardly, which can hold the holder member 30 for preventing the holder member 30 from overly moving along the upper-to-lower direction.

The resilient member 4 is a torsion coil spring, and presents as U-shaped. The resilient member 4 includes a first abutting portion 41 abutting rearwardly against the housing 1, and two second abutting portions 44 extending forwardly from the first abuting abutting portion 41 to press onto the holder member 30 of the optical module 3. The resilient member 4 is wholly located in the mounting cavity 121. The first abutting portion 41 can swing in the mounting cavity 121 along the front-to-rear direction. The first abuting portion 41 includes a circle portion 42 attached to the shaft 1211, a pair of horizontal portion 43 extending outwardly from the circle portion 42 along the transverse direction respectively. The horizontal portions 43 abut against the vertical surface 1213 of the blocks 1212 respectively. The horizontal portions 43 are symmetrical with each other relative to the central line C1.

The two second abuting portions 44 have a same abuting force pressed on holder member 30 due to the second abutting portion 44 are symmetrical with each other relative to the central line C1. It could limit the holder member 30 from moving along the transverse direction while the optical module 3 is sliming along the front-to-rear direction. The second abutting portions 44 each includes an inclined portion 45 extending outwardly and slantly from the horizontal portion 43, and a vertical portion 46 extending upwardly from a front end of the inclined portion 45 and abuting forwardly press onto the holder member 30 of the optical module 3. Two vertical portions 46 are also symmetrical with each other relative to the central line C1.

The metal shell 7 comprises an upper shell 71 covering the base portion 11, and a lower shell 72 assembling with the upper shell 71 to enclose the insulative housing 1. The lower shell 72 encloses the tongue portion 12 and has a top wall 721 resisting a lower surface of the tongue 12, a bottom wall 722 opposed to the top wall 721 and a pair of side walls 723 bending and extending downwardly from the top wall 721 to the bottom wall 721. The top wall 721 has a barb 7210 protruding downwardly to resist the optical module 3. A receiving space 725 is formed among the tongue portion 12, the bottom wall 722, and the contacts 2 for receiving the corresponding mating connector.

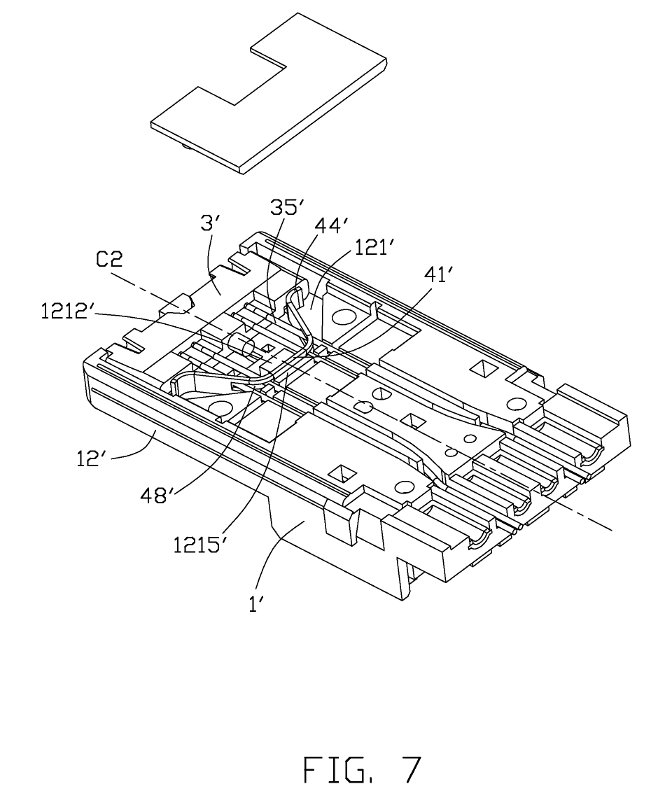

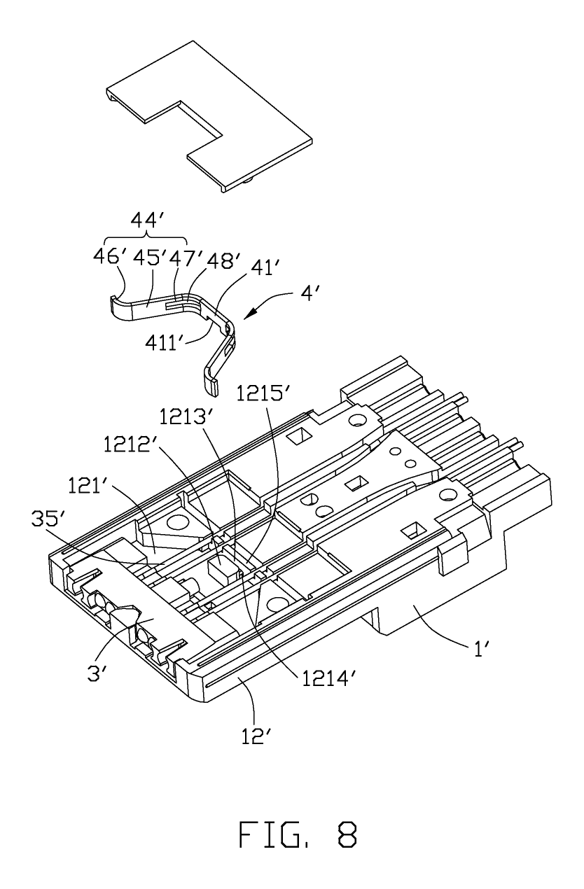

Referring to FIGS. 7-8, an optical connector 100′ according to a second embodiment is disclosed. The cable assemblies 100, 100′ in the first and second embodiments are similar to each other, and have a small difference. The optical connector 100′ includes an insulative housing 1′ with a tongue portion 12′ extending forwardly, an optical module 3′ movable retained in the tongue portion 12, a resilient member 4′ sandwiched between the optical module 3′ and the housing 1′ along a front-to-rear direction. The tongue portion 12′ defines a mounting cavity 121′ recessed downwardly from a top surface thereof, a first block 1212′ located in a rear portion of the mounting cavity 121′, and a second block 1215′ rearwardly spaced away from the first block 1212′ to define a retaining slot 1213′ therebetween. A protrusion 1214′ is connected between the first block 1212′ and the second block 1215′ and located in a bottom portion of the retaining slot 1213′. The optical module 3′ also defines a central line C2 along a middle portion thereon in the front-to-rear direction.

The resilient member 4′ is stamped from a metallic sheet or made of plastic material and presents as U-shaped. The resilient member 4′ is wholly symmetrical relative to the central line C2 along a transverse direction perpendicular to the front-to-rear direction. The resilient member 4′ includes a first vertical abuting plate 41′ pressing rearwardly onto the second block 1215′, and a pair of second abuting plates 44′ extending outwardly from the first abuting plate 41′ respectively. The first abuting plate 41′ defines a cutout 411′ recessed on a bottom edge thereof and corresponding to the protrusion 1214′. The first abuting plate 41′ is retained in the retaining slot 1213′ to be sandwiched between first block 1212′ and the second block 1215′ for preventing the first abuting plate 41′ from moving along the front-to-rear direction. The protrusion 1214′ of the tongue portion 12′ is retained in the cutout 411′ for preventing the first abuting plate 41′ from moving along the transverse direction.

The second abuting plates 44′ each includes an inclined plate 45′ extending slantly outward, a horizontal plate 46′ extending outwardly from the inclined plate 45′, and an arc bending plate 47′ bending and extending outwardly from the first abuting plate 41′ to the inclined plate 45′. The bending plates 47′ each defines a through hole 48′ through which fibers 35′ of the optical module 3′ passing. Therefore, The fibers 35′ can slightly move in a small range both in the transverse direction and the upper-to-lower direction when the optical module 3′ moves. The second abuting plates 44′ are symmetrical relative to the central line C2 along the transverse direction to support an equal force pressing onto the optical module 3′. Therefore, the optical module 3′ can not move along the transverse direction when the optical module 3′ is moving in the receiving cavity 121′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An optical connector, comprising:
an insulative housing defining a mounting cavity;
an optical module accommodated in the mounting cavity and capable of moving therein along a front-to-rear direction, the optical module defining a horizontal central line along a middle portion thereof in the front-to-rear direction;
at least one fiber coupled to the optical module; and
a resilient member located behind the optical module, and having a first abuting portion engaged with the insulative housing, and two second abuting portions extending forwardly from the first abutting portion and pressing onto the optical module;
wherein the two second abuting portions are spaced away from each other in a transverse direction perpendicular to the front-to-rear direction.

2. The optical connector as claimed in claim 1, wherein the resilient member is made of metallic or plastic material, and presents as U-shaped.

3. The optical connector as claimed in claim 1, wherein the second abuting portions are located at two lateral sides of the central line respectively.

4. The optical connector as claimed in claim 1, wherein the resilient member is wholly symmetrical relative to the central line along the transverse direction.

5. The optical connector as claimed in claim 1, wherein the housing includes a base portion, a tongue portion extending forwardly from the base portion and a upright shaft located in the mounding cavity, the central line is along a middle portion of the shaft, the mounding cavity is formed on the tongue portion, the resilient member is a torsion coil spring, the first abuting portion includes a circle portion attached to the shaft.

6. The optical connector as claimed in claim 5, wherein the housing defines a pair of blocks disposed on two opposite sides of the shaft and located within the mounting cavity, the blocks are spaced away from the shaft along a transverse direction respectively, the first abuting portion further includes a pair of horizontal portion extending outwardly from the circle portion and pressing rearwardly onto the blocks respectively.

7. The optical connector as claimed in claim 6, wherein the second abuting portions each includes an inclined portion extending outwardly and slantly from the horizontal portion, and a vertical portion extending upwardly from a front end of the inclined portion and pressing forwardly onto the optical module.

8. The optical connector as claimed in claim 1, wherein the housing defines a first block, a second block spaced away rearwardly from the first block to define a retaining slot therebetween, a protrusion and located in a bottom portion of the retaining slot, the second block is located in the mounting cavity, the first abuting portion is retained in the retaining slot, and defines a cutout recessed on a bottom edge thereof and corresponding to the protrusion for preventing the first abuting portion from moving in the transverse direction.

9. The optical connector as claimed in claim 1, wherein the second abuting portions each includes an inclined portion extending slantly outward, a horizontal portion extending outwardly from the inclined plate, and a bending portion bending and extending outwardly from the first abuting portion to the inclined portion, the horizontal portions press forwardly onto the optical module.

10. The optical connector as claimed in claim 1, wherein the optical module includes a holder member movable in the mounting cavity along the front-to-rear direction, and at least one fiber attached to the holder member, the holder member is formed with at least one lens at a front side thereof, the resilient member defines a through hole through which the fiber passing.

11. An hybrid connector for transmission of electrical and optical signals, comprising:
an insulative housing defining an electrical mating port and an optical mating port offset from the electrical mating port in both a mating direction and a vertical direction perpendicular to said mating direction;
a plurality of contacts disposed in the housing and exposed to the electrical mating port;
an optical module assembled to the optical mating port, said optical module including a holder member, a plurality of lenses retained in the holder member, and a plurality of rearwardly extending fibers connected to the corresponding lenses, respectively; and
a resilient member constantly urging the lenses forwardly;
wherein the resilient member has a pair of abuting portions pressing onto the optical module for regulating said fibers in a transverse direction perpendicular to both said mating direction and said vertical direction, the pair of abuting portions are spaced away from each other in a transverse direction to define a connect portion connected therebetween.

12. The hybrid connector as claimed in claim 11, wherein the optical module defines a central line along a middle portion thereof in the mating direction, the resilient member is wholly symmetrical relative to the central line along the transverse direction, and directly urges said holder member forwardly, thus resulting in urging the lenses forwardly.

13. The hybrid connector as claimed in claim 11, wherein the housing defines a upright shaft located in the optical port, the resilient member is a torsion coil spring, the connect portion includes a circle portion attached to shaft, a pair of horizontal portions extending outwardly from the circle to press rearwardly onto an inner wall of the mating port.

14. The hybrid connector as claimed in claim 11, wherein the housing has a first block, a second block spaced away rearwardly from the first block and located in the optical mating port, and a protrusion disposed between the first block and the second block, the connect portion is sandwiched between the first block and the second block for preventing the resilient member from moving in the mating direction, and defines a cutout formed on a bottom edge thereof, the protrusion is retained in the cutout for preventing the resilient member from moving in the transverse direction.

15. The hybrid connector as claimed in claim 11, wherein the connect portion defines a through hole through which fibers passing forwardly, the contacts are based on the USB 3.0 standard.

16. An electrical connector for mating with a complementary connector, comprising:
an insulative housing having thereof a platform to define an electrical area and an optical area at first and second levels, respectively;
a plurality of electrical contacts having stiff and resilient contacting sections thereof, and disposed in the housing at the first level; and
an optical module having fibers and lenses thereon, located at the second level, said optical module being back and forth movable relative to the housing in a mating direction; wherein
a resilient device constantly urges the optical module forwardly under condition that said resilient device provides two forward abutment regions spaced from each other in a transverse direction, which is perpendicular to said mating direction, to constantly urge said optical module forwardly.

17. The electrical connector as claimed in claim 16, wherein said resilient device further includes a rearward abutment region located around a center line between and behind said two forward abutment regions.
